(19) United States
(12) Patent Application Publication
(10) Pub. No.: US 2006/0246244 A1
(43) Pub. Date: Nov. 2, 2006

(54) Disposable vessel for the containment of biological materials and corrosive reagents

(76) Inventors: Lauri Laurene Jenkins, Newark, DE (US); Jay Irving Kennedy, Circleville, OH (US); Victor Sisto Lusvardi, Chadds Ford, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/412,328

(22) Filed: Apr. 27, 2006

Related U.S. Application Data
(60) Provisional application No. 60/676,347, filed on Apr. 29, 2005.
(60) Provisional application No. 60/676,339, filed on Apr. 29, 2005.
(60) Provisional application No. 60/721,819, filed on Sep. 29, 2005.

(51) Int. Cl. B32B 27/32

(52) U.S. Cl. 428/35.2

(57) ABSTRACT

A package is provided, comprising a fluoropolymer bag and an overwrap, the package being terminally sterilized so as to obtain and maintain the sterilization condition of the fluoropolymer bag, which can then be made available as a sterilized, disposable vessel for biological material and corrosive reagents.

### FIELD OF THE INVENTION

This invention relates to a disposable vessel useful for the containment of biological materials and corrosive reagents.

### BACKGROUND OF THE INVENTION

Biological material includes living cells and the cellular products, which are non-living, expressed from the living cells during the cell culturing/expression process. The manufacture of biological material such as therapeutic proteins such as by recombinant DNA technology involves multiple steps, including formation of the genetically altered cell line, fermenting or culturing the cell line to express the protein, including the preparation of the nutrient medium, purifying the protein, including the preparation of protein separation solutions, and formulating and storing the protein. The protein is subject to undesirable alteration and even denaturing by the presence of contaminants in any of the solutions containing the protein in one or more of the manufacturing steps. For commercial operation, the vessels used in carrying out the steps in the process are primarily stainless steel, thought to be corrosion resistant and thus non-contaminating to the different media present in the manufacturing steps. With the use of stainless steel, however, the manufacturing line has to be shut down periodically for clean-in place operations (between production batches) and corrosion remediation. The stainless steel vessels show effects of corrosion, such as “rouging” or pitting of the interior surface of the vessel, which indicates that the vessel has contributed to contamination of the medium contained in the vessel. The clean-out process is costly, involving such steps as cleaning of the vessel, electro-polishing its interior surface, sterilizing the resultant surface, and validation that the re-furbished vessel can be returned to service. The loss of production and possibly loss of therapeutic protein that led to the shut down is also costly. The same problem exists for the containment of corrosive reagents typically associated with biological material, especially in their manufacture, such as ultra-pure water, usually called water for injection (WFI), acids, buffers and bases, so that such reagents do not become a source of contamination of the biological material.

U.S. Pat. No. 6,684,646 discloses a flexible container for the storage of biopharmaceutical materials, the container being configured to conform to the shape of the interior of a temperature controlled unit (for cooling or freezing the contents of the container) or the shape of a protective structure adapted to receive the container. The container is sterile and is formed of a laminated film, which includes a plurality of layers. The product-contacting layer, i.e. the interior layer of the container is disclosed to be biocompatible and may be formed from a wide variety of polymeric materials, mentioning the following: low density polyethylene, very low density polyethylene, ethylene vinyl acetate copolymer, polyester, polyamide, polyvinylchloride, polypropylene, polyfluoroethylene, polyvinylidenefluoride, polyurethane, or fluoroethylenepropylene. A gas and water vapor layer and a mechanical strength layer are present, and an external layer with an insulating effect to heat welding is also present. The layers may be compatible with warm and cold conditions and may be able to withstand ionizing radiation for sterilization.

The problem of the flexible container contaminating the biopharmaceutical is not addressed in the above-mentioned patent. The fact that the container is used for storage of the biopharmaceutical results in long periods of contact between the biopharmaceutical and the contact layer of the container, enabling the biopharmaceutical to extract organic components from the contact layer of from other layers used in the laminate that permeate through the contact layer into the biopharmaceutical contents. Contamination can reduce or eliminate the efficacy of the biopharmaceutical and/or produce harmful results to which the biopharmaceutical is administered.

U.S. Pat. No. 4,847,462 discloses the laser manufacture of disposable bags made from films of various fluoropolymers, for use for culturing (growing) cells taken from the human body for eventual return to the human body, thereby providing cellular immunotherapy. The laser seaming operation is carried out in a box that is kept sterile and which includes germicidal lamps to prevent mold growth and kill all bacteria. The film is water-rinsed as an additional measure for achieving film cleanliness. An air knife directing sterile air to dry the water rinsed film is also disclosed. The problem remains on how to provide a non-contaminating surface for the vessels used in the containment of biological material and corrosive reagents, so as to avoid the need for and expense of periodic shut down and clean out, and to provide such surface in sterilized form to the user.

### BRIEF SUMMARY OF THE INVENTION

The present invention solves this problem by providing a vessel that has a non-contaminating surface and is furthermore disposable, so that the expense of loss of biological material from the effect of contamination and clean out is avoided and shut down is limited to merely replacing the vessel. Furthermore, the vessel is provided to the user in sterilized condition, whereby the vessel is ready for containment application by the user, such as installation of the vessel in the desired step of the manufacturing process. Thus, the vessel is capable of being used in a wide variety of containment applications for biological material and corrosive reagent addition to the biological material, such as in all of the therapeutic protein manufacturing steps disclosed above.

To satisfy these needs, the present invention provides a terminally sterilized package comprising a sealed overwrap and containing a flexible bag made of film at least the interior surface of the bag being melt-fabricable fluoropolymer, with the proviso that when said fluoropolymer is perfluoropolymer, said package is terminally sterilized by exposure to radiation. The sterilized bag is the vessel that can be used as described in the preceding paragraph. Terminally sterilized means that the flexible bag is sterilized after sealing within the overwrap. The preferred method of sterilization involves exposing the flexible bag through the overwrap to gamma radiation. This sterilizes the bag and the interior of the overwrap and the overwrap maintains the sterilized condition until the package is opened by the user, such as the protein manufacturer. When the film is a monolayer of perfluoropolymer, it is preferred that the radiation sterilization be done by electron-beam (e-beam) radiation.

The bag is considered sterilized if all forms of life, especially microorganisms, are destroyed or eliminated in accordance with the definition of the term sterilization” on p. 21 of S. S. Block, Disinfection, Sterilization and Preservation, fifth Edition, 2001 by Lippincoft Williams & Wilkins. The U.S. Food and Drug Administration (FDA) also defines sterilization in somewhat greater detail as a process intended to remove or destroy all viable forms of microbial life, including bacterial spores, to achieve an acceptable sterility assurance level, citing the Association for Advancement of Medical Instrumentation (AAMI), 1995 (p. 25 of Block). The FDA also defines “Sterility assurance level” and “Sterile” and these definitions are incorporated herein by reference (p. 25 of Block). The sterilization intended in the present invention satisfies both these general and more specific definitions.

In satisfying this sterility requirement, the sterilized bag present in the terminally sterilized package must be non-contaminating with respect to the biological material and/or corrosive reagent that will eventually be contained therein. The fluoropolymer film from which that least the interior surface of the bag is made is organic. The resistance to extraction of organics from the fluoropolymer has been demonstrated by filling a bag with water for injection (WFI), the bag being made entirely of the fluoropolymer as a monolayer film. WFI is defined in United States Pharmacopeia (USP) 1231 under Water for Pharmaceutical Purposes. In substance, WFI ultra pure water, the purity of which is designed to prevent microbial contamination and the formation of microbial endotoxins. WFI is also well known as being a highly corrosive material, which provides a severe test of extractability of organics (organic compounds) from any polymer container. Resistance to extraction is determined by maintaining the copolymer container being tested and containing 250 ml of the WFI at 40° C. for 63 days, followed by analysis of the WFI for organics, that could only come from (by extraction from) the fluoropolymer. For the above-described bag, no organics were found in the WFI present in the bag under the above conditions. The detection limit for the analysis was 50 ppb. Further details on the analysis as part of the extraction test and the application of this test to other test liquids and other polymers are disclosed later herein.

More than resistance to extraction is desired for a commercially useful disposable container. The preferred sterilization method is gamma radiation, with the radiation dosage of about 25 to 40 kGy generally considered to be adequate to provide the sterilization. Gamma radiation is known to both degrade and crosslink fluoropolymers. Y. Rosenberg et al., “Low Dose γ Irradiation of Some Fluoropolymers; Effect of Polymer Chemical structure”, J. of Applied Science, 45, John Wiley & Sons, 783-795, discloses that the radiation of ethylene/tetrafluoroethylene copolymer (ETFE), which is a preferred fluoropolymer for the fluoropolymer interior surface of the bag, causes a competition between crosslinking and chain scission events (Synopsis on p., 783). Chain scission is the degradation of the copolymer.

The resistance to extraction of organics of the fluoropolymer film bag described above exists for the bag having been sterilized by exposure to gamma radiation (25-40 kGy) prior to the conduct of the extraction test. Surprisingly, the chain scission that accompanies the exposure to radiation does not result in the film container contaminating the contents of the container with organics.

The preferred method of sterilization involves exposing the flexible bag through the overwrap to a sterilizing effective amount of gamma radiation. This sterilizes the container, both its interior and exterior surfaces, and the interior surface of the overwrap and the overwrap maintains the sterilized condition until the package is opened by the user for storage of the biological material. For ETFE, the integrity of the container is substantially unaffected by the exposure to gamma radiation. One manifestation of the retained integrity of the container is that the tensile strength and elongation at break of the gamma irradiated (25-40 kGy) ETFE film making up the container being at least 80% of that for the same copolymer film prior to such radiation, more preferably at least one of these properties being even less affected by the radiation, i.e. being at least 90% of tensile strength or elongation of the copolymer film prior to the radiation. These attributes apply to the fluoropolymer film by itself or as a laminate to other polymer layer(s) making up the film.

While gamma radiation is the preferred method of sterilizing the container of the present invention, because of the effectiveness of this method of sterilization and because of industry acceptance, other forms of sterilizing radiation, such as E-beam radiation can be used to provide the effective amount of radiation needed to accomplish sterilization, typically from about 25 to about 40 kGy. This radiation is less penetrating into the fluoropolymer film, but has the advantage of being less degradative of the fluoropolymer, which can be important at least when the fluoropolymer is perfluoropolymer. Alternatively, the package of the present invention can be sterilized by exposure to steam in an effective amount to provide the sterilization result.

Another aspect of the present invention is the preferred process for providing the disposable vessel applicable to the containment of biological material and corrosive reagents, comprising providing a flexible film comprising melt-fabricable fluoropolymer, fabricating said film into a bag for use as said vessel so that at least the interior surface of said bag is made of said fluoropolymer, sealing said bag within an overwrap, exposing said bag through said overwrap to an effective amount of radiation to sterilize said bag, said overwrap maintaining the sterilization of said bag until it is opened. The flexible film comprising the fluoropolymer can be made entirely of said fluoropolymer or can be a laminate of said fluoropolymer with other layer(s) of different polymer as will be described hereinafter. The combination of the overwrap and bag contained within the overwrap forms the package described above.

Preferably the overwrap is also flexible, so that the package can lay relatively flat. It is also preferred that the interior of the overwrap is under vacuum, which facilitates that flat formation of the package. It is also preferred that any gas present within said overwrap be a gas that is inert during the terminal sterilization, e.g. nitrogen or argon. Depending on the extent of the vacuum, the amount of such gas will be relatively small. The inert gas purges the interior of the overwrap, and thus the exterior and interior of the bag contained within the overwrap, of air. The purging step is carried out prior to sealing of the overwrap.

### DETAILED DESCRIPTION OF THE INVENTION

The flexible bags of the present invention are especially useful in containing cell cultures during culturing to express a different cellular product such as proteins, therapeutic or non-therapeutic, toxins, and polysaccharides and the expressed cellular product during subsequent treatments such as recovery, formulation and storage, and the corrosive reagents that are used in this production of the cellular product.

The cell culturing occurring in the expression of a different cellular product differs from the cell culturing that involves only the growing of the original cells, without creating a different cellular product. The latter cell culturing is represented for example by the immunotherapy application for the disposable bags in U.S. Pat. No. 4,847,462. In contrast, the cell culturing occurring in the expression process produces a non-living cellular product from the living, growing cell culture. This different cellular product is more susceptible to harm from organics contamination than the host cell culture. The host cell culture is a living organism and can therefore make some adjustment to counteract such contamination. The expressed cellular product, because it is not a living organism, cannot make this adjustment. Consequently, the likelihood of an organic (contamination) to organic (cellular product) reaction to adversely affect the cellular product is much greater. In addition, the cellular product is a small fraction of the cell culture from which the cellular product is expressed. Therefore, an amount of organics contamination that might be small relative to the cell culture will be large relative to the amount of cellular product. Another difference from mere cell culturing is that the expression process is usually carried out in a succession of reactors of increasing volume, within each of which the cell culturing is conducted until optimum density is reached. The cell culture/expressed cellular product medium is thus exposed to a plurality of bioreactor surfaces in advancing from one bioreactor to the next, thereby being subject to contamination by each reactor surface, instead of exposure to only one container surface as in the case of mere cell culturing, i.e. unaccompanied by expression of different product. The surprising resistance to extraction of organics from the fluoropolymer forming at least the interior surface of the container(s) (bioreactors) in which the expression process is carried out enables the cellular product to be preserved as formed for supply to the step(s) of recovering this product from the biomass within which it was produced. This is especially surprising when the container is sterilized prior to use as the bioreactor by exposure to degradative ionizing radiation, such as by gamma radiation, as will be further described hereinafter.

Examples of biological material that can be stored in the flexible bag include biologic cellular material such as therapeutic protein, non-therapeutic protein, vaccines other than protein, antibodies, activators, nucleic acids, genetic code bases, polysaccharides, and toxins. Nutrient medium and activator (induction agent) for use in the expression process may also be stored in flexible bags of the present invention. Similarly, the corrosive reagents that may be used in the expression process, subsequent isolation of the expressed cellular product, or its formulation, such as WFI, acids, bases, buffers, can also be prepared and stored in flexible bags of the present invention, so that addition of any of these reagents to the cellular product will not contaminate it with organic contaminate. Typically, the biological material will be liquid at room temperature (15-20° C.) either by itself or as contained in an excipient formulation. The biological material upon formulation may include buffer to maintain pH constant, salts for increased solubility, and/or other excipients such as stabilizers, antimicrobials, preservatives, surfactants, antioxidants, and/or isotononicity agents, to maintain efficacy. Adjuvants, which enhance immune response to an antigen, may also be added as part of the formulation process. Excipients and adjuvants may also be prepared and stored in separate flexible bags of the present invention, so that they too do not contaminate the biological material when added thereto. After addition of the biological material to the container, the filled container will typically be stored at temperatures of about −5 to −80° C.

The fluoropolymers used in the present invention are melt-fabricable, which means that they are sufficiently flowable in the molten state (heated above its melting temperature) that they can be fabricated by melt processing, preferably extrusion such as to form a flexible film. Typically, the fluoropolymer by itself is melt-fabricable; in the case of polyvinyl fluoride, the fluoropolymer is mixed with solvent for extrusion, i.e. solvent-aided extrusion. The resultant film has sufficient strength so as to be useful. The melt flowability of the fluoropolymer can be described in terms of melt flow rate as measured in accordance with ASTM D-1238, and the fluoropolymers of the present invention preferably have a melt flow rate of at least 1 g/l 0 min, determined at the temperature which is standard for the particular fluoropolymer; see for example, ASTM D 2116a and ASTM D 3159-91a. Polytetrafluoroethylene (PTFE) is generally not melt processible, i.e. it does not flow at temperatures above the melting temperatures, whereby this polymer is not melt-fabricable. Low molecular weight PTFE is available, called PTFE micropowder, the molecular weight being low enough that this polymer is flowable when molten, but because of the low molecular weight, the resultant molded article has no strength. The absence of strength is indicated by the brittleness of the article. If a film can be formed from the micropowder, it fractures upon flexing. In contrast, the melt-fabricable fluoropolymers used in the present invention can be formed into films that can be repeatedly flexed without fracture. This flexibility can be further characterized by an MIT flex life of at least 500 cycles, preferably at least 1000 cycles, and more preferably at least 2000 cycles, measured on 8 mil (0.2 mm) thick compression molded films that are quenched in cold water, using the standard MIT folding endurance tester described in ASTM D-2176F. The flexibility of the container enables it to collapse into a flattened shape. Flexibility can also be confirmed by attempting to puncture the film from which the container is made, such as by following the procedure of ASTM F1342, with the result that prior to puncture, the stylus used in the puncture test deflects the film from its planar disposition in the test to the extent of at least about 5 times the thickness of the film being tested, and preferably at least 10 times the film thickness.

The fluoropolymers used in the present invention are also such that the film made therefrom is optically clear. Optical clarity is desired so that when the film is fabricated into a bag used in the present invention, the interior of the bag can be observed through the film wall of the bag, enabling the observer to confirm that no visible contaminant is present. PTFE film is not optically clear. The fluoropolymers are also non-adherent with respect to the liquid contents of the bag, i.e. the biological materials and/or corrosive reagent such as used in the protein manufacturing process, i.e. neither the liquids nor the ingredients contained therein adhere to bag made from the fluoropolymer film.

The preferred melt-fabricable fluoropolymers for use in the present invention comprise one or more repeat units selected from the group consisting of —CF₂—CF₂—, —CF₂—CF(CF₃)—, —CF₂—CH₂—, —CH₂—CHF— and —CH₂—CH₂—, these repeat units and combinations thereof being selected with the proviso that said fluoropolymer contains at least 35 wt % fluorine, preferably at least 50 wt % fluorine. Thus, although hydrocarbon units may be present in the carbon atom chain forming the polymer, there are sufficient fluorine-substituted carbon atoms in the polymer chain to provide the desired minimum amount of fluorine present, so that fluoropolymer exhibits chemical inertness. The fluoropolymer preferably also has a melting temperature of at least 150° C., preferably at least 200° C., and more preferably at least 240° C. Examples of perfluoropolymers, i.e., wherein the monovalent atoms bonded to carbon atoms are all fluorine, except for the possibility of other atoms being present in end groups of the polymer chain, include copolymers of tetrafluoroethylene (TFE) with one or more perfluoroolefins having 3 to 8 carbon atoms, preferably hexafluoropropylene (HFP). The TFE/HFP copolymer can contain additional copolymerized perfluoromonomer such as perfluoro(alkyl vinyl ether), wherein the alkyl group contains 1 to 5 carbon atoms. Preferred such alkyl groups are perfluoro(methyl vinyl ether), perfluoro(ethyl vinyl ether) and perfluoro(propyl vinyl ether). Typically, the HFP content of the copolymer is about 7 to 17 wt %, more typically 9 to 17 wt % (calculation: HFPI x 3.2) and the additional comonomer when present constitutes about 0.2 to 3 wt %, based on the total weight of the copolymer. The TFE/HFP copolymers with and without additional copolymerized monomer is commonly known as FEP. Examples of hydrocarbon/fluorocarbon polymers (hereinafter “hydrofluoropolymers”) include vinylidene fluoride polymers (homopolymers and copolymers), typically called PVDF, copolymers of ethylene (E) with TFE, typically containing 40 to 60 mol % of each monomer, to total 100 mol %, and preferably containing additional copolymerized monomer such as perfluoroalkyl ethylene, preferably perfluorobutyl ethylene. These copolymers are commonly called ETFE. While ETFE is primarily composed of ethylene and tetrafluoroethylene repeat units making up the polymer chain, it is typical that additional units or from a different fluorinated monomer will also be present to provide the melt, appearance, and/or physical properties, such as to avoid high temperature brittleness, desired for the copolymer. Examples of additional monomers include perfluoroalkyl ethylene, such as perfluorobutyl ethylene, perfluoro(ethyl or propyl vinyl ether), hexafluoroisobutylene, and CH₂═CFR_{f} wherein R_{f} is C₂-C₁₀ fluoroalkyl, such as CH₂═CFC₅F₁₀H, hexafluoropropylene, and vinylidene fluoride. Typically, the additional monomer will be present in 0.1 to 10 mol % based on the total mols of tetrafluoroethylene and ethylene. Such copolymers are further described in U.S. Pat. Nos. 3,624,250, 4,123,602, 4,513,129, and 4,677,175. Additional hydrofluoropolymers include EFEP and the copolymer of TFE/HFP and vinylidene fluoride, commonly called THV. When the fluoropolymer is hydrofluoropolymer, terminal sterilization can be carried out by other than exposure of the bag within the overwrap to radiation; the package comprising the overwrap and the bag contained therein can be terminally sterilized by exposure to steam. Films of these perfluoropolymer and hydrofluoropolymers are all commercially available. Typically, the film from which the bag is made will have a thickness of 2 to 20 mils (0.05 to 0.5 mm), preferably 2 to 10 mils (0.25 mm)

In one embodiment of the present invention, the fluoropolymer forms the entire thickness of the film, whereby the interior surface of the bag formed from the film is also of fluoropolymer. The mono (single) layer film has the advantage of avoiding the need to laminate or otherwise bond a fluoropolymer film or layer to another film or layer to form a laminate. This has the further advantage in forming seams in the fabrication of the film into a bag. The seam will involve heat bonding fluoropolymer to itself and edges of the film present in the seam in the interior of the bag will be entirely fluoropolymer. The heat bonding will not have to heat through the entire thickness of a laminate containing the fluoropolymer film as a layer that will form the interior surface of the bag, wherein the laminate may contain lower melting polymer layer(s).

In another embodiment, the fluoropolymer film is part of a flexible film laminate, with the fluoropolymer forming the innermost or contact layer of the bag made from the laminate and the intermediate and outer layers being those such as described for the non-contact layers of the laminate in U.S. Pat. No. 6,684,646. The thickness of the fluoropolymer film layer in the laminate can be the same as described above, but preferably will be no greater than about 10 mils (0.25 mm).

The bag can have any configuration and size desired for the particular application, such as in one or more steps in the manufacture of therapeutic proteins or other cellular product. For example, the bag can be formed from two sheets of film heat sealed together along their edges to form an envelope. Alternatively, the bag can be formed from sheets of film to form a bag with distinct bottom and sides, either to form a round-sided bag or one with distinct sides coming together at corners. Whatever the configuration, the bag forms a container or vessel, within which a step in the protein manufacture or other application can be carried out. Since the bag is made of flexible film, the bag itself is flexible. The bag can be open at the top (in use) or can be closed, except for a port of entry for the medium to be made, processed or stored. The port of entry can simply be a length of tubing heat sealed to the film forming the bag. The entry port can be located elsewhere in the bag and additional openings can be provided, such as equipped with tubing heat sealed to the film of the bag, for such processing activities as discharge of the media from the bag, feed of gas to the bag, or multiple gases as in the case when the bag is used as the bioreactor, wherein both oxygen and nitrogen are introduced to the fermentation broth/nutrient medium or cell culture/nutrient medium in the bag, and an additional port is provided to enable carbon dioxide to vent from the bag. An additional port can be provided for the introduction of a mixing blade into the interior of the bag. Examples of bag configurations are those shown in U.S. Pat. Nos. 5,941,635, 5,988,422, 6,071,005, 6,287,284, 6,432,698, 6,494,613, 6,453,683, and 6,684,646.

The interior volume of the bag can be such as to accommodate either the research manufacture of the protein or the commercial manufacture thereof. Typically, the volume of the bag will be at least 500 ml, but more typically, at least 1 liter, but sizes (volumes) of at least 10 liter, at least 50 liter, at least 100 liters, and at least 1000 liters, and even at least 10,000 liters are possible. Since the fluoropolymer film can be made in practically unlimited length, it is only necessary to cut this length into the lengths desired and fabricate these lengths together to form the bag with the configuration and size desired. Small bag sizes can be used unsupported, while a rigid support can be used for larger bag sizes. The rigid support could be simply a base upon which the bag rests or a container within which the bag is positioned so that both the bottom and side(s) of the bag are supported. When the rigid support will be necessary will depend on the size of the bag and its film thickness. The rigid support can be existing vessels used in the manufacture of therapeutic protein, whereby the bag forms a disposable liner for the vessel. The disposable liner is formed separately from the rigid support and therefore can be placed on or into the rigid support for carrying out the process of the present invention, and can be removed from the support upon completion of the process. This is in contrast to a permanent liner that is formed on and adhered to the inner surface of the vessel.

The bag can be formed by heat sealing one or more sheets of film of the fluoropolymer together, depending on the size and configuration of the bag. Heat sealing involves welding overlapping lengths of the film together by applying heat to the overlap. The welding is achieved by heating the overlapped surfaces, usually under pressure, such as by using a heated bar or hot air, impulse, induction or ultrasonic heating. The overlapping film surfaces are heated above the melting temperature of the fluoropolymer to obtain a fusion bond of the overlapping film surfaces. An example of heat sealing of overlapping films of FEP (melting temperature of about 260° C.) is as follows: A pair of hot bars are heated to 290° C. and pressed against overlapping FEP film having a total film thickness of 5 mils (0.125 mm) under a pressure for 30 psi to provide the fusion seal in 0.5 sec. For ETFE, overlapping films each 4 mils (0.1 mm) thick, the hot bars of the impulse sealer are heated to 230° C. and a pressure of 60 psi (42 MPa) for about 10 sec to obtain the fusion seal. Lower temperatures can be used for lower melting fluoropolymers. Typically the heat sealing can be completed in no more than 15 sec. Additional information on heat sealing is provided in S. Ebnesajjad, Fluoroplastics, Vol. 2. Melt Processible Fluoropolymers, published by Plastics Design Library 2003, pp. 493-496. The ports of entry into the bag can be welded to the film by heat sealing techniques or by the welding and sealing techniques applied to various fluoropolymers as disclosed on pp. 461-493 of Fluoroplastics.

After fabrication of the bag, it is inserted into a sealable overwrap, which is sized to enable the bag to fit within the overwrap. Preferably, the flexibility of the bag enables it to collapse to be substantially flat, whereby the overwrap can have a smaller interior volume than the volume of the bag. Alternatively, the bag may be folded over upon itself, which enables an even smaller size overwrap to be used. The overwrap itself is preferably flexible and therefore formed from a polymer film such as of about 1 to 10 mils (0.025 to 0.25 mm) in thickness. Since the overwrap is not used in the manufacture of the protein, it does not have to have the non-contaminating character of the fluoropolymer bag with respect to the manufacture of the protein. Inexpensive polymer films such as of polyolefin such as polyethylene or polypropylene, or polyester, such as polyethylene terephthalate can be used as the overwrap. The polymer film making up the overwrap can be formed into a bag of the size and shape desired by heat sealing using conditions suitable for the particular polymer being used. The same heat sealing can be used to seal the overwrap once the fluoropolymer bag is inserted into the overwrap.

Sterilization is carried out on the package resulting from the sealed overwrap containing the fluoropolymer bag, preferably by exposing the package to ionizing radiation, preferably gamma radiation, in an effective dosage to achieve sterilization of the fluoropolymer bag. Typically, such dosage is in the range of about 25 to 40 kGy. AAMITIR 17-1997 discloses guidance for the qualification of polymeric materials that are to be sterilized by radiation, including certain fluoropolymers. By way of example, a bag made of two sheets of FEP film, each 5 mil (0.125 mm) thick, heat sealed together as described above on three sides to leave an open top and having a capacity of 5 liters is formed. Alternatively, a bag is made of two sheets of ETFE film, each 4 mils (0.1 mm) thick, heat sealed as described above. A bag of similar size of polyethylene terephthalate (PET) film 1.2 mil (0.03 mm) thick is also formed, and the FEP or ETFE bag is placed within the PET bag. The PET bag is heat sealed using an AudionVac-VMS 103 vacuum sealing machine operating on program 2 to heat seal the overlapping films of the PET bag with a 2.5 sec dwell time of a hot bar pressing the films together against an anvil. The machine first inflates the PET bag, followed by drawing a vacuum of 1 Bar on the interior of the bag, and then carrying out the heat sealing. The resultant vacuum sealed PET bag with the collapsed FEP or ETFE bag inside forms a flat package. The resultant package is exposed to gamma radiation from a C⁶⁰ source to provide a dosage of 26 kGy, which is a sufficient dosage to sterilize the FEP or ETFE bag within the PET overwrap. Alternatively the radiation exposure can be by electron beam at the same radiation dosage to sterilize the package, including the fluoropolymer bag contained therein. The PET overwrap maintains the sterilized condition of the FEP or ETFE bag until the PET overwrap is unsealed to make the bag available as a container for use in the manufacture of therapeutic protein. As stated above, steam terminal sterilization can be used when the fluoropolymer from which the bag is made is hydrofluoropolymer.

A gusseted container is made by heat sealing flexible films of FEP or ETFE together at their edges. This container when filled with liquid medium has a rectangular shape when viewed from one direction and an upstanding elliptical shape when viewed in the perpendicular direction. Thus, the container when filled (expanded) has the shape of a pillow. This container can also be oriented in the horizontal direction so that a gusseted sidewall faces upward. The orientation of the container will determine where the ports (openings) are positioned. In the embodiment next described, the container is oriented vertically, so that the gusseted sidewalls are vertical. The gussets can be formed from separate pieces of film or can be formed integrally with the sidewall. For example, a heat-sealed film in the shape of a tube can be pinched to form inwardly extended pleats, which are heat sealed at their top and bottom to retain the pleat shape, when the container is collapsed. The bottom and top of the tube shape is heat sealed to form the container. When the container is expanded, the pleats unfold at their midsections, to form gussets in the side of the container. In a different embodiment, the elliptical-shaped sidewalls of the container are made from FEP or ETFE film cut into this elliptical shape. The sidewalls are heat sealed to the rectangular front and back walls of the container by impulse heating, which involves a controlled heat-up applied to overlapping film portions, clamped between a heat bar and an anvil, heat sealing of the clamped film portions together, and controlled-cooling of the seal while still under clamping pressure. The heat bar and anvil are shaped to the configuration needed for the desired shape of the heat seal. One or more ports are provided at the top of the container spaced along the upper rectangular edge as may be required for the particular utility of the bag in the manufacture of the therapeutic protein. For example, one port is provided and a second port is provided for entry for a mixing blade. A single port is also provided at the bottom rectangular edge of the container for drainage of liquid contents of the container. Except for the presence of the ports, the container is a closed vessel. Each port is formed from tubing that has valve for opening and closing the tubing. The tubing is heat sealed to the film wall of the container by impulse heating to the film walls of the container, i.e. the tubing is sandwiched between films forming opposite sides of the container and sealed around and to the periphery of the tubing. Alternatively, the port(s) can be integral with a base having tapered ends and the base is heat sealed to the opposing films. The interior volume of this container is 200 liters. When inflated by the addition of liquid medium, the container can be supported within a rectangular tank, the bottom edge of the container resting on the bottom of the tank, which has an aperture through which the tubing of the three bottom ports can extend, and the elliptical sidewalls being supported by the corresponding sidewalls of the tank, and the rectangular sidewalls contacting the corresponding sidewalls of the tank to provide support. After fabrication of this container, the flexibility of the FEP or ETFE film enables the container to collapse into a flat shape, which can be heat sealed into an overwrap and then sterilized by exposure of the resultant sealed package to gamma radiation as described in the preceding paragraph. The gamma radiation also sterilizes the ports heat sealed into the bag.

Details of the testing for extraction of organics from polymer film containers that had been subjected to 40 kGy gamma radiation are as follows:

The container of flexible film is filled with 250 ml of WFI or other test liquid and the resultant filled container is heated at 40° C. for 63 days. During this time, the corrosive WFI or other test solution has the opportunity to extract organics (organic compounds) from the film from which the container is made. Whether this extraction occurs or the extent of its occurrence is determined by subjecting samples of the WFI or other test liquid, as the case may be, to separation by gas chromatography, followed by analysis of the separation products by detection means. Volatile organic compounds (VOC) extracted in this process and separated in an HP 6890 GC (column :SPB-1sulfur, 30 m×0.32 mm ID, 4.0 micrometer thick film, operating at a range of 50-180° C.) are determined using a flame ionization detector (FID). The sample of test liquid is injected into the column at a temperature at 270° C. The flame detection pattern is electronically compared to a library of patterns in order to identify the organic present in the WFI or other test liquid. The separation of individual VOCs is based on retention time in the column, and the identification of the VOCs is done by their ionization signature.

Higher molecular weight organics that might be extracted from the stored, heated container can be considered as semi-volatile organic compounds (semi-VOC) and are also subjected to separation in a GC column, followed by detection of any semi VOC present. The column used for separating samples of the WFI or other test liquid is a GC (HP 6890) column, 30 m×250 micrometer ID, utilizing a 0.25 micrometer HP-5MS film, and the separated sample passing through the column is analyzed by Mass Spectrometer (MS) analysis using an HP 5973 MSD analyzer. The sample is injected into the column at 220° C. For the semi-VOC analysis the sample of WFI or other test liquid is spiked with 1000 ppb of 2-fluorobiphenyl (internal detection standard) and extracted several times with methylene chloride. The VOCs and semi-VOCs form a boiling point continuum of the organics that might be extracted from the container of polymer film being tested. The limits of detection of the VOCs and semi-VOCs are 50 ppb. The reporting of zero (0) for detection of extractables from the WFI and other test liquids in Tables 1 and 2 means that if extractables were present, they were present in less than 50 ppb.

The heated storage conditions for the WFI or other test liquid in the flexible film container, together with the GC separation of any organics present in a sample of the test liquid after such storage in the container, and analysis of the GC effluent can simply be referred to herein as the extraction test (long term).

As stated above, with respect to the containers of flexible film of fluoropolymer and containing WFI, no organics were detected in the extraction test.

The results of subjecting bags of fluoropolymers film and of film of different polymers to WFI and to other extractants to the extraction test are shown in Tables 1 and 2.

TABLE 1
Comparison of Extraction Test Results - Semi-VOC

| | Organics in Extraction Liquid | | | |
|---|---|---|---|---|
| | After Extraction (ppb) | | | |
| Extractant liquid | FEP | ETFE | EVA* | PE** |
| WFI | 0 | 0 | 0 | 570 |
| 1N HCl, 15 wt % NaCl | 0 | 0 | 0 | 0 |
| 1N NaOH, 15 wt % NaCl | 0 | 0 | 74 | 70 |
| PBS (phosphate buffered saline) | 0 | 0 | 0 | 210 |
| Guanidine HCl | 0 | 0 | 0 | 395 |

*laminate in which ethylene/vinyl acetate copolymer is the interior layer
**laminate in which ultra low density polyethylene is the interior layer.

TABLE 2
Comparison of Extraction Test Results - VOC

| | Organics in Extraction Liquid | | | |
|---|---|---|---|---|
| | After Extraction (ppb) | | | |
| Extractant liquid | FEP | ETFE | EVA | PE |
| WFI | 0 | 0 | 1395 | 2946 |
| I N HCl, 15 wt % NaCl | 0 | 0 | 2820 | 2961 |
| 1 N NaOH, 15 wt % NaCl | 0 | 0 | 1247 | 1997 |
| PBS (phosphate buffered saline) | 0 | 0 | 1271 | 1820 |
| Guanidine HCl | 0 | 0 | 1127 | 1200 |

These extractants (challenge solutions) shown in Tables 1 and 2 mimic liquids that may be included in the biological material by virtue of the process for producing the biologic material, such as in the manufacture of cellular product such as therapeutic protein. As shown in these Tables, the bags made of either FEP film or ETFE film were far superior to the bags made from the indicated hydrocarbon polymers as the interior layer of the bag, i.e. the hydrocarbon contact layers were much more contaminating of the various extraction test liquids. The organics detected in the extraction liquids in the EVA and/or PE bags included the following: ethanol, isopropanol, and dimethyl benzenedicarboxylic acid ester. It is surprising that the FEP and ETFE films do not yield extractables, because the effect of the gamma radiation on these polymers is to cause degradation, by polymer chain scission, this effect being more severe for the FEP than the ETFE as shown by the physical test results in Tables 3 and 4.

The variability of the extraction results with the hydrocarbon polymer bags, i.e. different challenge liquids give different extraction results for the same bag, is a cause of concern for the user because the extraction results with still different reagents, as may be encountered in use, are unpredictable. In contrast, the consistently low extraction values for the fluoropolymers give confidence that this will extend to different reagents.

Another test was conducted in which samples of the bags mentioned above were exposed to desorption conditions in a clean stainless steel tube of a Perkin-Elmer ADT400. The tube was heated at 50° C for 30 min to generate volatiles from the bag sample. The resultant gases were then subjected to GC separation (HP 6890 GC) at a column temperature of 40° C. to 280° C. and calibrated with n-decane, and mass spectrometer analysis (HP 5973 MS detector). This is the outgas test. The detection limit is 1 ppm (I microgram/gm). No outgas was detected for either the FEP film or the ETFE film. For the PE film, 67 ppm of organics were detected, which included isopropyl alcohol, branched alkane hydrocarbons, octane, alkene hydrocarbons, decane, dodecane, alkyl benzenes, 2,6-di-tert-butyl benzoquinone, 1,4-benzenedicarboxylic acid, dimethyl ester, and 2,4-bis(I,I-dimethylethyl)-phenol. For the EVA film, 140 ppm of organics were detected, which included acetic acid, heptane, octane, branch alkane hydrocarbon, octamethyl cyclotetrasiloxane, decamethyl cyclopentasiloxane, alkyl benzenepolysiloxane, alkyl phenol, and 2,6-di-tert-butyl benzoquinone.

The container made from film of either tetrafluoroethylene/-hexafluoropropylene copolymer or ethylene/tetrafluoroethylene copolymer exhibits far superior stability under exposure to conditions of extraction and outgasing.

The effect of gamma radiation on physical properties of several fluoropolymers was tested. Tensile strength and elongation was tested on extruded films 4 to 5mil (102-127 micrometers) thick in accordance with ASTM D 638, before and after exposure to 40 kGy gamma radiation, with the results being as reported in Table 3.

TABLE 3
Tensile Strength and Elongation of Fluoropolymer films

| | ETFE | PVDF | FEP |
|---|---|---|---|
| Tensile strength, psi (MPa) | | | |
| Before radiation | (62.3)8900 | (56)8000 | (42.7)6100 |
| After radiation | (52.5)7500 | (56.7)8100 | (26.6)3800 |
| Elongation at break, % | | | |
| Before radiation | 430 | 310 | 460 |
| After radiation | 440 | 140 | 450 |

These results show that the radiation greatly weakens the PVDF (polyvinylidenefluoride) and FEP (tetrafluoroethylene/hexafluoropropylene copolymer), greatly reduced tensile strength in the case of FEP and greatly reduced elongation in the case of PVDF. The reduction in elongation for PVDF manifests itself as reduced flexibility for the film making up the container, making it prone to cracking upon flexing.

The effect of 40 kGy of gamma radiation on fluoroethylene (polytetrafluoroethylene) is even more severe than for the PVDF and FEP. Both tensile strength and elongation deteriorate to lower levels than for the PVDF and FEP.

The films forming the subject of testing, the results of which are shown in Table 3,were also subjected to tear resistance testing in accordance with ASTM D 1004-94a, wherein the test specimen has a notch stamped therein as shown in FIG. 1 of the ASTM test procedure. In this test, the test specimen is gripped between pairs of jaws and pulled apart at a rate of 51 mm/min, which concentrates the stress at the notch in the test specimen. As the jaws are pulled apart, a graph of load required vs. extension of the test specimen in the notch region is formed. The resultant curve is plotted until the load reaches a peak and then declines 25% from the peak or until the specimen breaks, whichever occurs first. The area under the curve as determined by the computer program MathCAD represents the energy required to break the film. This test simulates the localized stresses that might be imposed on the container made from the film, such as might be encountered by contact with a sharp object or development of internal pressure within the liquid contents of the container. High load accompanied by low elongation in the tear resistance test has the disadvantage that the film will tend to puncture rather than elongate when subjected to localized stress. Moderate load accompanied by high elongation provide greater resistance to puncture. Table 4 shows the energy to break for the films of Table 3.

TABLE 4
Energy to Break

| | Gamma Radiation | Energy at Break |
|---|---|---|
| Film | Dosage(KGy) | (cm · N/cm) |
| ETFE | 0 | 2250 |
| | 25 | 2695 |
| | 40 | 2694 |
| PVDF | 0 | 1205 |
| | 25 | 1033 |
| | 40 | 753 |
| FEP | 0 | 1085 |
| | 25 | 1819 |
| | 40 | 1567 |

These results were obtained at room temperature (15-20° C.) tear resistance testing, averaging 5 test films/radiation condition. The energy at break values is normalized to the thickness of the film being tested, which accounts for the “cm” in the denominator.

It is preferred in the present invention that the energy at break of the film after exposure to 40 kGy of gamma radiation is at least 90% of that of the film prior to the radiation exposure, more preferably is at least as great after the radiation exposure as before. Table 4 shows no loss in energy at break for the ETFE film, when exposed to gamma radiation and substantially greater energy at break than either the PVDF or the FEP.

These physical testing results show that the ethylene/tetrafluoroethylene copolymer film bag is preferred over bags made from either PVDF or FEP because of the gamma radiation sterilizability of the ethylene/tetrafluoroethylene copolymer bag without appreciable detriment to either extraction of volatile compounds or in physical properties significant to the utility of the bag. Thus, the FEP and PVDF films used to make the flexible container according to the present invention should preferably be sterilized by methods other than gamma radiation, e.g. by exposure to e-beam radiation or by exposure to steam. If gamma radiation were used to sterilize perfluoropolymer such as FEP or radiation-degraded hydrofluoropolymer such as PVDF, these fluoropolymers would preferably be in the bag to be sterilized as the interior surface (film) of a laminate, in which the outer layer(s) of the laminate would be essentially not degraded by the radiation. Examples outer layer polymers are those disclosed above for use as the overwrap of the terminally sterilized package.

What is claimed is:

1. A terminally sterilized package comprising a sealed overwrap and containing a flexible bag made of film, at least the interior surface of which is melt-fabricable fluoropolymer, with the proviso that when said film is made entirely of said melt-fabricable fluoropolymer and said melt-fabricable fluoropolymer is perfluoropolymer, said package is terminally sterilized by exposure to radiation.

2. The terminally sterilized package of claim 1 wherein said overwrap is flexible.

3. The terminally sterilized package of claim 1 wherein the interior of said overwrap is under vacuum.

4. The terminally sterilized package of claim 1 wherein said overwrap also contains an inert gas.

5. The terminally sterilized package of claim 1 wherein said fluoropolymer is hydrofluoropolymer.

6. The terminally sterilized package of claim 5 wherein said hydrofluoropolymer is ethylene/tetrafluoroethylene copolymer.

7. The terminally sterilized package of claim 1 wherein the terminal sterilization of said package is carried out by exposing said package to radiation.

8. A process for providing a disposable vessel applicable to the containment of biological material and corrosive reagents, comprising providing a flexible film comprising melt-fabricable fluoropolymer, fabricating said film into a bag for use as said vessel so at least the interior surface of said bag is said fluoropolymer, sealing said bag within an overwrap, exposing said bag through said overwrap to an effective amount of radiation to sterilize said bag, said overwrap maintaining the terminal sterilization of said bag until it is opened.

9. The process of claim 8 wherein said fluoropolymer comprises one or more repeat units selected from the group consisting of —CF₂—CF₂—, —CF₂—CF(CF₃)—, —CF₂—CH₂—, —CH₂—CHF— and —CH₂—CH₂—, with the proviso that said fluoropolymer contains at least 35 wt % fluorine.

10. The process of claim 9 wherein said fluoropolymer is tetrafluoroethylene/hexafluoropropylene copolymer or ethylene/tetrafluoroethylene copolymer.

11. The process of claim 8 wherein said radiation is gamma or electron beam radiation.

12. The process of claim 11 wherein said radiation is gamma radiation and said film from which said bag is made exhibits at least 80% of the tensile strength and elongation of said film prior to said radiation.

13. A terminally sterilized package comprising a sealed overwrap and containing a flexible bag made of film, at least the interior surface of which is made of melt-fabricable fluoropolymer, the interior of said sealed overwrap being under vacuum.

14. A terminally sterilized package comprising a sealed overwrap and containing a flexible bag made of film, at least the interior surface of which is made of melt-fabricable fluoropolymer, the interior of said overwrap being purged of air by inert gas.
